(19) United States
(12) Patent Application Publication
(10) Pub. No.: US 2026/0347221 A1
(43) Pub. Date: Nov. 5, 2026

(54) COMPOSITION AND METHOD OF MAKING POLYMER MEMBRANE

(71) Applicants: Naif S Aljohani, Jeddah (SA); Manal M khowdiary, MAKKAH (SA); Mohammed Abdel Salam, MELBOURNE, FL (US); Radwan K Al-Farawati, JEDDAH (SA); Mohamed A Abdel-Fadeel, JEDDAH (SA); Khairia M Al-Ahmary, JEDDAH (SA); Abeer M Alsoaimi, TAIF (SA); Aliyah S Alhawiti, TABUK (SA); Saedah R Al-Mhyawi, JEDDAH (SA)

(72) Inventors: Naif S Aljohani, Jeddah (SA); Manal M khowdiary, MAKKAH (SA); Mohammed Abdel Salam, MELBOURNE, FL (US); Radwan K Al-Farawati, JEDDAH (SA); Mohamed A Abdel-Fadeel, JEDDAH (SA); Khairia M Al-Ahmary, JEDDAH (SA); Abeer M Alsoaimi, TAIF (SA); Aliyah S Alhawiti, TABUK (SA); Saedah R Al-Mhyawi, JEDDAH (SA)

(21) Appl. No.: 19/197,356

(22) Filed: May 2, 2025

(51) Int. Cl. C02F 1/44; B01D 61/22; B01D 67/00; B01D 69/12; C02F 101/20; C02F 103/08

(52) U.S. Cl. CPC C02F 1/44; B01D 61/22; B01D 67/0083; B01D 69/1216; B01D 2325/021; B01D 2325/025; B01D 2325/0282; C02F 2101/20; C02F 2103/08; C02F 2209/03; C02F 2209/06

(57) ABSTRACT

A method and composition of synthesis of a polymer membrane to remove the heavy metals from water during desalination process is disclosed. The polymer membrane was characterized using processes such as SEM, FTIR, contact angle, thickness and porosity. The polymer membrane reduced heavy metals compared to other membranes was more efficient. The polymer membrane specifically showed a better adsorption efficiencies of heavy metals such as Cd, Cu, Pb, Co, Zn and Cr. The maximum efficiency was observed at a pH of 8 and operating pressure of 6 Pa.

### FIELD OF TECHNOLOGY

The instant disclosure describes a composition and method of polymer membrane to remove heavy metals during desalination of water.

### BACKGROUND

The demand of potable water to the whole world is increasing dramatically due to the contamination of the available water on the surface of the earth. Many countries around the world, particularly developing countries and Middle Eastern countries, are suffering from a scarcity of fresh water resources. Surface water and groundwater resources provide nearly all of the world's potable water. The overuse of potable water has resulted in a decrease in surface water and groundwater availability. Around 97.5 percent of water resources from 1.4 billion km³ of total global water reserves belong to the ocean, with only 0.014 percent available to humans and other organisms. Several traditional treatments and protocols have been used to remove pollutants (including metal ions) from water, including chemical precipitation, microbial decomposition, and physical adsorption. These pollutants are inherently harmful to the environment (i.e. plants, animals, ecology, and climate) and to humans. However, heavy metal removal using conventional protocols (such as flotation, chemical precipitation, ion exchange, adsorption, and electrochemical deposition) remains difficult, necessitating additional efforts to avoid the production of a large amount of toxic sludge and liquid waste, long time consumption, and extreme use of supplies (e.g., solvents, resins, among others), as well as poor separation efficiency.

Because of its ease of use, membrane separation has recently become more popular for the treatment of inorganic effluent. Membrane adsorbent technology, which was developed in the mid-1980s, is a membrane integration technology. Adsorption is a mass transfer process that occurs when a substance moves from the liquid phase to the surface of a solid and becomes bound by physical and/or chemical interactions. Adsorbents can capture heavy metal ions in aqueous solutions via physical or chemical adsorption. Chemical adsorption is more commonly used for heavy metal removal because it has stronger interactions and a higher capacity for heavy metal adsorption. Membranes are used in a variety of prominent large-scale advanced treatment approaches used around the world for artificial groundwater recharge, indirect potable reuse, and industrial process-water production. Among the emerging membrane technologies used on a large scale for resource recovery (i.e. water) from wastewater treatment plants are ultrafiltration, nanofiltration, and reverse osmosis. Polymeric membranes are likely the most commonly used membranes for water treatment applications to date, including treatment of agro-food wastes, textile, petroleum industry streams, acid mine waters, and seawater. The merging of both materials to produce nanocomposite membranes is a current trend in the field of developing new membrane materials, and it is also a promising tool for the efficient removal of heavy metals. However, there is a dearth of reviews of the latest nanocomposite membrane concepts and their role in water treatment and heavy metal separation. Very recently, novel breakthroughs in tailoring nanocomposite materials have been released, such as nanoscale zerovalent iron impregnated biochar entrapped in calcium-alginate matrix, MnO₂/chitosan, core-shell structured nanocomposite of zero-valent iron with carbon, Fe₃O₄/GO composite introduced into graphitic carbon nitride g-C₃N₄. The main polymer materials used in the manufacture and production of membranes for pressure-driven membrane processes are polyethersulfone (PES), polysulfone (PSF), PAN, polytetrafluoroethylene, polypropylene, and PVDF. When used in water treatment applications, most of these materials are known to have excellent permeability, selectivity, and acceptable chemical, mechanical, and thermal stability. PSF and PES membranes, in particular, are the most commonly used materials in the production of UF membranes. There is a need for more efficient membrane technology to address heavy metal contaminants for large scale operations such as desalination.

### SUMMARY

In this disclosure a method to prepare an efficient polymeric membrane to decontaminate the heavy metals from the brine water is disclosed. In one embodiment, Modified Resin Added Polymer Membrane with 8-hydroxyquinoline (MRMP) was composed and method of making is described. The polymer membrane was made using 8-hydroxyquinolone and other chemicals to remove heavy metal from brine. The polymer membrane shows maximum efficiency at a pH of 8 and an operating pressure of 6 Pa, conditions that are often found in industrial settings, making it practical for real-world applications. The integration of 8-hydroxyquinoline enhanced the membrane's adsorption efficiency, providing a significant improvement over traditional materials which may suffer from rapid fouling and lower separation efficiency.

### BRIEF DESCRIPTION OF DRAWINGS

Example embodiments are illustrated by way of example and not limitation in the figures of the accompanying drawings, in which like references indicate similar elements and in which:

FIGS. 1A, 1B and 1C shows SEM characterization of PM; RPM, and MRPM.

FIGS. 2A, 2B and 2C shows The FTIR Characterization of the materials

FIGS. 3A, 3B and 3C shows Removal efficiency at pH 8 and varying pressure using PM, RPM, and MRPM.

FIG. 4 shows the removal efficiency various metals at various pH.

Other features of the present embodiments will be apparent from the accompanying drawings and from the detailed description that follows.

### DETAILED DESCRIPTION

The samples were collected from the brine water of Jeddah desalination plant. In order to make a proper remediation of metals and salinity, three membranes were used in this study. The membranes were named as polymer membrane (PM), resin added polymer membrane (RPM), and modified resin added polymer membrane with 8-hydroxy quinoline (MRPM). Common ingredients for all three composition comprises of a thermoplastic resin, synthetic polymer and a cyclic compound that contains nitrogen and a powerful solvent. Examples of thermoplastic resin is Polyethersulfone (PES), synthetic polymer is Polyvinylpyrrolidone (PVP) and cyclic compound with solvent quality is N-methyl-2-pyrrolidone (NMP). Additionally Dowex® resin is used for Ion exchange in different separation, purification, and decontamination processes. MRPM specially uses 8-Hydroxyquinoline (8HQ), which is a small planar molecule with a lipophilic effect and a metal chelating ability. The amounts of ingredients used for casting solutions to fabricate the membranes are shown below in the Table 1.

TABLE 1
The amounts of ingredients of the casting
solutions of the fabricated membranes

| | | | | 8-hydroxy | |
|---|---|---|---|---|---|
| Material | (PES) g | (PVP) g | Resin (g) | quinoline (g) | (NMP) g |
| PM | 15 | 5 | 0 | 0 | 80 |
| RPM | 15 | 5 | 2 | 0 | 78 |
| MRPM | 15 | 5 | 2 | 2 | 76 |

*(PES) Polyethersulfone,
*(PVP) Polyvinylpyrrolidone,
*(NMP) (solvent) N-methyl-2-pyrrolidone,
*Resin (Dowex ® Resin),
*PM (Polymer Membrane), RPM (Resin added polymer membrane), and
*MRPM (RPM modified with 8-hydroxyquinoline).

The preparation of the polymer membranes, specifically the PM (Polymer Membrane), RPM (Resin Added Polymer Membrane), and MRPM (Modified Resin Added Polymer Membrane with 8-hydroxyquinoline), incorporates distinct formulations shown in table 1. Each type of membrane is created from a unique mix of materials blended into a casting solution, which is critical in determining their ultimate properties and functions. Starting with the PM, the formula consists of 15 grams of polyethersulfone (PES), 5 grams of polyvinylpyrrolidone (PVP), and 80 grams of N-methyl-2-pyrrolidone (NMP), which acts as the solvent. This composition yields a foundational membrane structure geared towards general filtration purposes. The RPM formulation builds upon the PM by introducing an additional 2 grams of Dowex® resin and decreasing the NMP content to 78 grams to make room for the resin. This adjustment is designed to bolster the membrane's structural integrity and possibly enhance its ion-exchange capabilities, thereby making it more suitable for specialized filtration applications. Further advancing the design, the MRPM incorporates 2 grams of 8-hydroxyquinoline in addition to the ingredients used in the RPM. This additive is intended to confer specific chemical characteristics to the membrane, such as enhanced adsorption capabilities or refined filtration efficiencies. To accommodate these additional components while maintaining an appropriate viscosity, the amount of solvent (NMP) is reduced to 76 grams. Each step from PM to MRPM demonstrates careful alterations in the chemical composition of the membranes, aimed at customizing their properties for more specialized applications. This progression signifies a thoughtful and systematic approach to the design of functional materials in membrane technology.

Preparation of casting solution: First, by 1 hour sonication, the precise amounts of Polymer/Resin were dispersed in the precise amounts of NMP (as solvent bath). The specific amounts of PVP (former porosity agent) are dissolved in the mixtures after 1 hour of sonication. To achieve homogeneous solutions, specific amounts of PES (as a base polymer) were dissolved in the mixtures after 1 hour of sonication and shook for 24 hours at room temperature. To eliminate all air bubbles, the homogeneous mixtures were heated for 2 hours in a 50 °C oven. After cooling to room temperature, the mixtures were poured onto a clean scratch-resistant glass plate, cast with a 0.2 mm thick casting knife, and immediately immersed in DIW (as a non-solvent bath) at room temperature to coagulate membranes. The manufactured membranes were deposited in fresh DIW for 24 hours and dried at room temperature for 24 hours between the filter paper pads to achieve full phase separation.

Membrane Experiment: The batch tests were done in a cell with permeation. Flat circular membranes inside the permeation cell were positioned over support located in the basement. The effective membrane areas with effective diameters of 5×10⁻² m is 1.96×10⁻³ m². Using the compressed air, the cell was pressurized and the permeate was extracted from the bottom of it. The brine solution is added with 5 ppm of each Cu, Cd, Pb, Zn, Co, and Cr.

Membrane characterization: The thickness of each membrane was measured with an electronic outside micrometer set (Fowler IP54) at three different points on each membrane. The averages were computed. Membrane porosity was measured by first cutting dried membrane samples 1×1 cm and weighing them with a precision balance, then immersing the samples in kerosene overnight. The following day, PVDF membranes were weighed again, and samples were dried in an oven at 50 °C for 24 hours.

Contact Angle: Using Attension (Theta tensiometer), contact angle measurements were used to characterize the wetting ability of a membrane surface. Membrane samples of 1×3 cm were placed on a sample stand using a double-sided tap, and the contact angle of the prepared membranes was measured using the Sessile drop method. The sessile drop was formed on the membrane surface by slowly dropping 4L of milli-Q water onto the membrane surface with a micro-syringe, and the average of three different locations was taken for each membrane.

FTIR Analysis: The Fourier Transform Infrared spectra (FTIR) Cary 630 FTIR Spectrometer (Agilent Technologies-USA) of the PVDF membranes were determined by using (ATR) technique, with a spectrum in the range of 4000-400 cm⁻¹.

SEM Analysis: The surface structure of the adsorbent was analyzed using a JXA-840A electron probe microanalyzer equipped with an EDAX unit. The analysis was performed at an acceleration voltage of 30 kV, with magnification capabilities ranging from 10× to 400,000×.

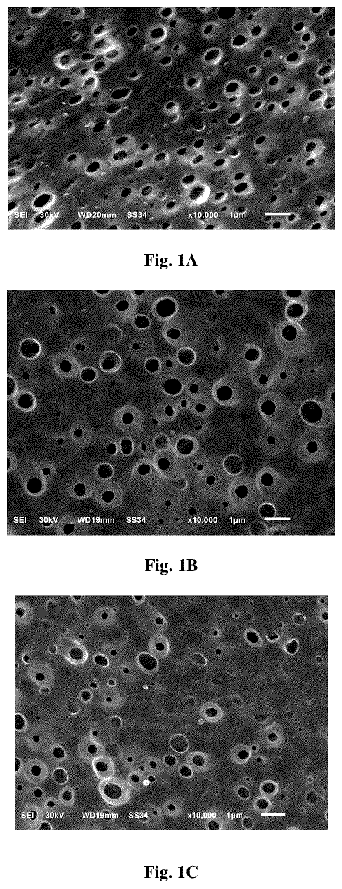

Characterization: FIG. 1A, FIG. 1B and FIG. 1C presents cross-sectional scanning electron microscopy (SEM) images of polyethersulfone (PES) membranes, highlighting modifications induced by the incorporation of Dowex® resin and 8-hydroxyquinoline. The images illustrate an asymmetric membrane structure, which typically features three distinct layers: a compact upper layer, a porous sublayer, and a base layer characterized by fully developed macropores. However, the SEM images in FIG. 1A, FIG. 1B and FIG. 1C demonstrates that the addition of Dowex® resin and 8-hydroxyquinoline impacts the membrane architecture by restricting the formation of these macropores. Moreover, this modification seems to enhance the structure of the pore distribution within the sublayer, fostering a well-defined, finger-like morphology. This alteration contributes to a denser and more structured upper layer, as observed in the SEM images, providing insights into the material's modified filtration characteristics and potential applications.

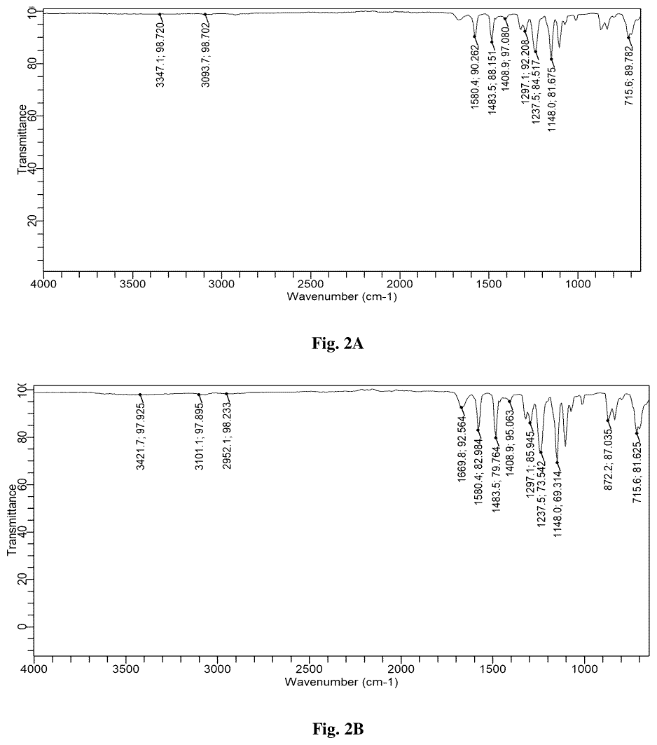

FTIR Characterization: The FIG. 2A is an illustration of a Fourier Transform Infrared (FTIR) spectroscopy graph that demonstrates the absorbance spectra for three different samples labeled as PM, RPM, and MRPM. Each spectrum within the graph is characterized by distinct peaks at various wavelengths, which are indicative of the different functional groups present within the samples. For the PM (Plain Membrane) (FIG. 2A), a peak near 1650 cm⁻¹ suggests C═O stretching vibrations typical of polymeric backbones like polyethersulfone, while a peak at around 3400 cm⁻¹ likely represents O—H stretching vibrations, pointing to the presence of hydroxyl groups or absorbed water in the membrane. The RPM (Resin-Modified PM) exhibits additional features (FIG. 2B); alongside the peaks found in PM, a distinct peak near 1450 cm⁻¹ is observable, potentially due to the bending vibrations of CH-2 groups, enhanced by the incorporation of Dowex® resin. Moreover, the intensity and slight shift of the peak around 3400 cm⁻¹ in RPM suggest an augmented hydroxyl or water content, likely due to the hydrophilic nature of the resin added. In the case of MRPM (Modified RPM with 8-hydroxyquinoline) (FIG. 2C), a new peak around 1500 cm⁻¹ is notable and could be attributed to N—H bending vibrations from amine groups introduced by 8-hydroxyquinoline. Another peak near 1720 cm⁻¹ in MRPM may indicate the presence of additional C═O groups, likely arising from chemical modifications or interactions between the resin and 8-hydroxyquinoline. Each spectrum elucidates the chemical modifications and interactions occurring within the membranes, offering insights into how each additive influences the overall structure and functionality of the membranes.

Thickness and Porosity: The porosity and thickness of the membranes used in this study are shown in the Table 2.

TABLE 2
Represent the porosity and thickness of the studied membranes:

| | Porosity | Thickness |
|---|---|---|
| Membrane | % | (mm) |
| PM | 70.4567 | 0.221 |
| RPM | 76.3248 | 0.224 |
| MRPM | 80.6578 | 0.227 |

The Table 2 offers a detailed comparative analysis of the porosity and thickness of three distinct types of membranes: PM (Plain Membrane), RPM (Resin-Modified PM), and MRPM (Modified RPM with 8-hydroxyquinoline), used in the recent study. The variations in both the physical and structural properties of these membranes are clearly outlined, demonstrating the impact of different treatments and modifications during their fabrication. For instance, the PM shows a porosity of 70.4567% and a thickness of 0.221 mm, indicating a denser structure which may influence its filtration efficiency and flow rate. On the other hand, the RPM displays a slightly higher porosity and thickness, at 76.3248% and 0.224 mm respectively, suggesting that the incorporation of Dowex® resin leads to a more open structure which could enhance the membrane's permeability and its ability to filter smaller particles. The MRPM, with the highest porosity and thickness values of 80.6578% and 0.227 mm respectively, shows that the addition of 8-hydroxyquinoline further increases structural openness, potentially improving performance in applications requiring high porosity such as selective filtration or targeted contaminant removal. The data encapsulates how chemical modifications can significantly alter the physical dimensions and structural properties of membranes, influencing their performance in specific applications. Each progressive increase in porosity and thickness from PM to RPM to MRPM aligns with the addition of chemical modifiers, highlighting a strategic approach to tailor membrane properties to meet particular functional needs.

Contact Angle: The contact angle reveals the wetting ability of the membrane surface. The contact angle of the membrane used in this study is shown in the Table 3.

TABLE 3
Represent the contact angle of the membranes

| Membrane | Contact Angle |
|---|---|
| PM | 72.36 |
| RPM | 74.12 |
| MRPM | 85.36 |

The Table 3 provides measurements of the contact angles for three different types of membranes: PM (Plain Membrane), RPM (Resin-Modified PM), and MRPM (Modified RPM with 8-hydroxyquinoline). The contact angle is an essential indicator of a membrane's surface wetting ability, which plays a critical role in its interaction with fluids, particularly in filtration and separation processes. The PM shows a contact angle of 72.36 degrees, indicating a moderate hydrophilicity. This balance between water repellency and absorption is typical for many polymeric materials used in membrane technology, where a slight hydrophilicity can be advantageous for certain filtration applications. The RPM has a slightly higher contact angle of 74.12 degrees, suggesting that the addition of Dowex® resin marginally increases the membrane's hydrophobic properties, possibly by altering surface roughness or introducing less water-absorbent functional groups. The MRPM exhibits a significant jump in contact angle to 85.36 degrees, reflecting a substantial increase in hydrophobicity due to the addition of 8-hydroxyquinoline, which enhances the membrane's resistance to water penetration. This property is beneficial in applications requiring reduced wetting and greater fouling resistance. The gradual increase in contact angles from PM to MRPM highlights how chemical modifications significantly influence the membranes' surface characteristics, affecting their suitability for various industrial and environmental applications. Each step-up in contact angle is directly linked to the introduction of specific chemical components that enhance the hydrophobic nature of the membranes.

The Removal Experiments of Heavy Metals: A variety of advanced adsorbents, including nanostructured metal oxides, carbon nanotubes, porous boron nitride nanosheets, and porous graphene, have been developed to improve the efficiency of heavy metal removal. To be effective, ion exchange membranes used in desalination must have high selectivity, excellent mechanical and chemical stability, and resistance to organic fouling. To achieve these characteristics, polymeric matrices were chosen, membranes were modified with different functional groups, and the membrane surface layer was used as a strategic tool. Generally, chemical adsorption is more popular for heavy metal removal because it has stronger interactions and higher adsorption capacity towards heavy metals. The special functional groups on the surface of the adsorbents provide significant interactions with heavy metals, resulting in the adsorptive separation of heavy metals from water. The study was targeted to remove heavy metals such cadmium (Cd), chromium (Cr), copper (Cu), lead (Pb), cobalt (Co), and zinc (Zn) from the brine water using different membrane including the resin added membrane. The experiments were performed with different pressure and different pH. Because of its unique properties, such as mechanical, thermal, and chemical stability, the polyethersulfone (PES) membrane is of particular importance. However, because of the lack of efficient adsorptive functional groups in its composition and its low separation efficiency, this membrane's separation performance is inherently poor due to the rapid fouling caused by extracted contaminants, which significantly increases its energy consumption and maintenance costs. As a result, the PES matrix must be modified by incorporating effective nanocomposites into its structure in order to improve separation efficiency, increase pure water flux, and reduce fouling characteristics.

The bare DOWEX® resin shows poor adsorption of heavy metals. However, the modified DOWEX® resin with 8-hydroxyquinolone shown an impressive adsorption capacity. According to the literature, 8-hydroxyquinoline (oxine) has applications for complexation of some heavy metal ions, and the nitrogen atom of the heterocyclic ring and the adjacent phenolic —OH group are suitable for chelation with heavy metal ions.

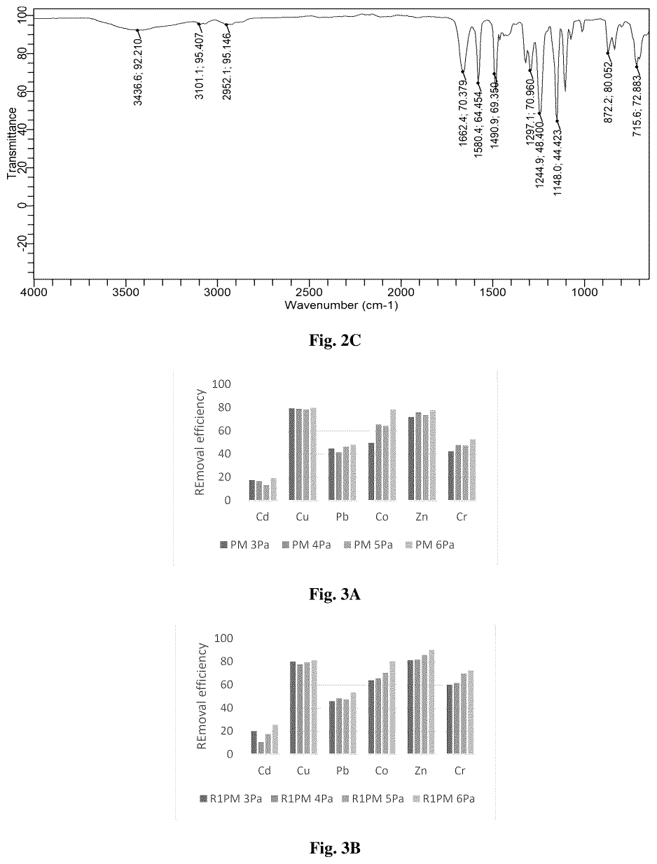

The removal experiments with varying pressure: Aside from membrane properties, working conditions such as operating pressure have a significant impact on the pure water flux and separation efficiency of membranes. To explain flux behavior, three factors can be used: (1) pore size, (2) electroviscous effect, and (3) osmotic pressure at the membrane surface. The study was conducted with the varying pressure from 3 Pa to 6 Pa. The removal efficiency of depicted heavy metals using different material is shown in the FIG. 3a-c.

FIG. 3A, FIG. 3B and FIG. 3C shows removal efficiency at pH 8 and varying pressure using PM, RPM, and MRPM. From the FIG. 3A, FIG. 3B and FIG. 3C, it is clear that for each element the highest adsorption was observed at 6 Pa pressure. The adsorption efficiency of elements were Cd (63.71%), Cu (83.33%), Pb (75.29%), Co (68.88%), Zn (90.48%), and Cr (82.40%) observed at 6 Pa pressure and with the modified DOWEX® added polymer membrane. During the modification of the polymer membrane, the efficiency was enhanced substantially. More interestingly, in all the three materials Zn was showing the maximum adsorption. The materials used in this experiments were polymer membrane, resin added membrane and modified resin added membrane. The better removal efficiency for all the 6 elements were achieved while using the modified resin added membrane. The water flux with pressure for different membranes, where it is observed that the flux increased almost linearly as pressure increased. This system can also achieve low pressure filtration because the modified resin added membrane has a larger nominal pore size and higher porosity than barrier-type membranes. As a result, energy consumption can be significantly lower than in RO or NF systems. Pressure drop across the resin bed during flow limits the ion exchange resin process, which can be exacerbated by media deformation and non-uniform packing. Several studies conducted to correlate the pressure drop across packed beds of ion-exchange resin with flow rate determined that the pressure drop must be known in order to effectively design an ion exchange process. Because there are a greater number of resin sites available for metal ion adsorption, the initial adsorption rate was fast. After 30 minutes of maximum metal ion removal, equilibrium is reached. As a result, a contact time of 30 minutes was chosen for future experiments.

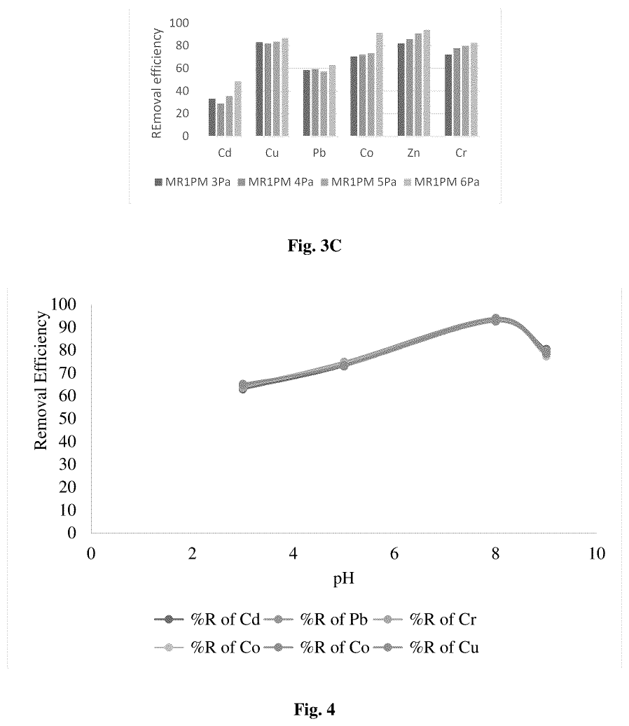

The removal experiments with varying pH: It is well known that pH is an important parameter for the adsorption of metal ions from aqueous solution because it affects the solubility of the metal ions in water, the concentration of the counter ions on the functional groups of the adsorbent, and the degree of ionization of the adsorbate during reaction. Adsorption of metal ions in an aquatic environment is influenced by the presence of H⁺ ions in a solution, as well as the adsorbed species and degree of ionization. Because of the very short contact distance at a submicron-scale level between the target pollutants and the adsorbed active binding site of the membrane adsorbents, when contaminated water flows through the membrane, the functional active binding sites combine with the target pollutants to remove contaminants from drinking water with a high adsorption rate and capacity. The effect of pH on the removal efficiency of the listed elements in this study is shown in the FIG. 4 using the DOWEX® added modified polymer membrane. In aqueous systems, the surface groups of sorbent can be protonated in different extents. Therefore, the concentrations of surface species of the sorbent change under different pH values.

FIG. 4. The removal efficiency various metals at various pH. With increasing pH, the negative charged groups or deprotonated groups increase and the hydrolysis of aforementioned elements also increases. The maximum removal efficiency was achieved at pH 8 for all the elements under the optimized pressure condition. The efficiency was gradually increasing from pH 4 to until the normal pH of the brine water (almost 8 in this study) then it starts declining slowly. The studies have also shown that polymeric membranes are usually positively and negatively charged at lower and higher pH values respectively. This study demonstrates that the surface charge of the membrane becomes more negative above pH 8 and less negative below pH 8. As a result, the higher rejection of elements at pH<8 could be explained by the mutual repulsion of the positively charged membrane and the metal ions. Similarly, the high rejection of elements at pH>8 could be attributed to the previously mentioned concept, namely repulsive forces between negatively charged ions and the membrane. The enhanced removal of metal ion as the solution pH was increased (more than 7) can be attributed to adsorption of hydrolytic product of each element and/or surface precipitation of the metal as the insoluble carbonates, MCO3, forming successive layers on the sorbent surface which may be explained in the following equation:

CaCO3o+M2++HCO3−→MCO3o+H+ (1)

MCO3o+M2++HCO3−→MCO3o+H⁺ (2)

The enhancement of the removal efficiency at higher pH i.e., pH 9 may be attributed to the precipitation of metals as metal oxides or carbonates as they tend to do so when pH of the solution increases above the solubility point. Therefore, pH 8 was recommended throughout all the other experiments.

### Industrial Applications:

Desalination Plants: The primary application of the modified membrane is in desalination plants, which are crucial for supplying potable water in regions with scarce freshwater resources. The membrane's enhanced ability to remove heavy metals such as Cd, Cu, Pb, Co, Zn, and Cr from brine water addresses a significant environmental challenge associated with desalination processes. By reducing heavy metal concentrations, the plant can prevent these contaminants from entering the drinking water supply and the broader environment, thereby adhering to stricter environmental regulations and public health standards.

Wastewater Treatment: Beyond desalination, the membrane's robust adsorption capabilities make it suitable for broader wastewater treatment applications. Industries that discharge heavy metals into water bodies can integrate these membranes into their treatment systems to lower metal concentrations before discharge, thus reducing environmental impact and complying with pollution control norms.

Resource Recovery: Another compelling application is in the field of resource recovery. The membrane's ability to selectively adsorb valuable metals from industrial effluents or mining runoffs offers a pathway to reclaim these resources for further use, adding economic value while mitigating environmental impacts.

Industrial Process-Water Production: In industries requiring high-purity water, such as pharmaceuticals, electronics, and food processing, the modified membrane can be employed to ensure the removal of trace metal contaminants, thus safeguarding product quality and process reliability.

1. A method of making a polymer membrane, comprising:
mixing a polymer, resin and a solvent in a specific amount;
sonicating the solution for an hour to form a mixture;
adding a thermoplastic polymer to the mixture, sonicating for an hour; and
shaking for 24 hours at room temperature to achieve a homogeneous solution.

2. The method of claim 1; further comprising:
Adding a specific amount of a 8-hydroxyquinolone to the homogeneous mixture; and
Heating the homogeneous mixture for 2 hours in an oven at 50 °C to eliminate all bubbles.

3. The method of claim 2, further comprising;
Drying the homogeneous mixture to form a sheet of polymer membrane.

4. The method of claim 3, further comprising;
Creating a flat circular filters from the sheet of polymer membrane and filtering heavy metals from a brine solution.

5. The method of claim 4, wherein the polymer is Polyvinylpyrrolidone, thermoplastic polymer is Polyethersulfone, and the solvent is N-methyl-2-pyrrolidone, and the resin is Dowex® Resin.

6. The method of claim 4, wherein the heavy metal is a Cd, Cu, Pb, Co, Zn and Cr.

7. A method of making a polymer membrane, comprising:
Adding a polymer, resin, solvent and 8-hydroxyquinolone to create a polymer membrane as a sheet; and
Filtering a heavy metal from brine using the polymer membrane sheet as a filter under a specific pressure and a specific pH to obtain a heavy metal free brine.

8. The method of claim 7, wherein the polymer is Polyvinylpyrrolidone, thermoplastic polymer is Polyethersulfone, and the solvent isN-methyl-2-pyrrolidone, and the resin is Dowex® Resin.

9. The method of claim 7, wherein the specific pressure is 6 Pa and the pH is 8.

10. The method of claim 7, wherein the heavy metal is a Cd, Cu, Pb, Co, Zn and Cr.

11. A method of making a polymer membrane, comprising:
mixing a polymer, resin and a solvent in a specific amount;
sonicating the solution for an hour to form a mixture;
adding a thermoplastic polymer to the mixture, sonicating for an hour; and shaking for 24 hours at room temperature to achieve a homogeneous solution;
shaking for 24 hours at room temperature to achieve a homogeneous solution;
adding a specific amount of a 8-hydroxyquinolone to the homogeneous mixture;
heating the homogeneous mixture for 2 hours in an oven at 50 °C to eliminate all bubbles;
drying the homogeneous mixture to form a sheet of polymer membrane that has three distinct layers; and
creating a flat circular filters from the sheet of polymer membrane and filtering heavy metals from a brine solution in a specific pH and a specific pressure.

12. The method of claim 11, wherein the polymer is a Polyvinylpyrrolidone, thermoplastic polymer is a Polyethersulfone, and the solvent is a N-methyl-2-pyrrolidone, and the resin is a Dowex® Resin.

13. The method of claim 11, wherein the heavy metal is a Cd, Cu, Pb, Co, Zn and Cr.

14. The method of claim 11, wherein the specific pressure is 6 Pa and the pH is 8.

15. The method of claim 11, wherein the sheet of polymer membrane has the layer that are distinct layers: a compact upper layer, a porous sublayer, and a base layer.

16. The method of claim 15, wherein the porous sublayer has a finger-like morphology for a pore.

17. The method of claim 12, wherein the ratio of the Polyvinylpyrrolidone 5 parts, the Polyethersulfone is 15 parts, the N-methyl-2-pyrrolidone is 76 parts, the 8-hydroxyquinolone is 2 parts and the Dowex® Resin is 2 parts.
